(19) United States
(12) Patent Application Publication
(10) Pub. No.: US 2026/0044289 A1
(43) Pub. Date: Feb. 12, 2026

(54) SYSTEM AND METHOD FOR DATA MANAGEMENT WITH ADAPTIVE RAID IN STORAGE DEVICES

(71) Applicant: Microchip Technology Incorporated, Chandler, AZ (US)

(72) Inventor: Ben Chan, San Mateo, CA (US)

(73) Assignee: Microchip Technology Incorporated, Chandler, AZ (US)

(21) Appl. No.: 19/236,052

(22) Filed: Jun. 12, 2025

Related U.S. Application Data
(60) Provisional application No. 63/681,248, filed on Aug. 9, 2024.

(51) Int. Cl. G06F 3/06

(52) U.S. Cl. CPC G06F 3/0689; G06F 3/0604; G06F 3/0655

(57) ABSTRACT

A system for data management provided. The system may include a processing circuitry, a memory coupled to the processing circuitry, a storage device coupled to the processing circuitry, a communication interface for data transfer with a host computer, a firmware stored in the memory which when executed by the processing circuitry, causes the processing circuitry to receive data from the host computer via the communication interface, distribute the data across the storage device in accordance with a selected RAID level, wherein RAID functionality is embedded within a single HDD and configured by a user, generate redundant data or parity information for the data based on the selected RAID level, store the data and corresponding parity information or the redundant data within the storage device, and manage one or more reclaim groups and one or more reclaim units within the storage device to place the data and manage garbage collection.

### CROSS REFERENCE TO RELATED APPLICATIONS

The present application claims priority to U.S. Provisional Patent Application No. 63/681,248, entitled: System and Method for Data Management with Adaptive RAID in Storage Devices, filed on Aug. 9, 2024, the contents of which are hereby incorporated by reference in their entirety.

### TECHNICAL FIELD

The present disclosure relates generally to data storage systems, and more specifically to a system and method for data management with adaptive RAID in storage devices.

### SUMMARY

According to an aspect of one or more examples, there is provided a system that may include processing circuitry, a memory coupled to the processing circuitry, a storage device coupled to the processing circuitry, a communication interface for data transfer with a host computer and a firmware stored in the memory. The firmware, when executed by the processing circuitry, may cause the processing circuitry to receive data from the host computer via the communication interface, and distribute the data across the storage device in accordance with a selected redundant array of independent disk (RAID) level. RAID functionality may be embedded within a single hard disk drive (HDD) and configured by a user. The processing circuitry may generate redundant data or parity information for the data based on the selected RAID level, store the data and corresponding parity information or the redundant data within the storage device, and manage one or more reclaim groups and one or more reclaim units within the storage device to place the data and manage garbage collection. The parity information and the redundant data may be inaccessible by the host computer.

The storage device may include a non-volatile memory (NVM). The processing circuitry may detect one or more errors in the data stored within the storage device. The processing circuitry may determine a reclaim group from the one or more reclaim groups or a reclaim unit from the one or more reclaim units with the one or more errors. The processing circuitry may use the parity information and a remaining portion of data blocks to recover the data from the determined reclaim group or reclaim unit. The processing circuitry may set an array status of the selected RAID level to a degraded mode in response to an uncorrectable error in the selected RAID level. The processing circuitry may perform XOR operation on the remaining portion of the data blocks from one or more operational reclaim units within the determined reclaim group and the parity information to reconstruct the data.

The processing circuitry may determine a reclaim group from the one or more reclaim groups or a reclaim unit from the one or more reclaim units with one or more errors and use the redundant data to recover the data from the determined reclaimed group or reclaim unit. The processing circuitry may set an array status of the selected RAID level to a degraded mode in response to an uncorrectable error in the selected RAID level. The processing circuitry may perform reconstruction of the data using mirrored data blocks of the redundant data from one or more operational reclaim units within the determined reclaim group. The processing circuitry may perform dividing of the data into the data blocks and distributing the data blocks across the one or more reclaim groups and the one or more reclaim units.

The processing circuitry may perform the XOR operations on corresponding data blocks within each reclaim unit across the one or more reclaim groups to generate the parity information which may be inaccessible by the host computer. The processing circuitry may perform the XOR operations within each of the one or more reclaim groups to generate two sets of the parity information when the selected RAID level is RAID-6. The two sets of the parity information may be inaccessible by the host computer. The processing circuitry may retrieve mirrored data blocks from the redundant data within each of the one or more reclaim groups to reconstruct the data when the selected RAID level is RAID-1. The redundant data may be inaccessible by the host computer. The processing circuitry may receive a database management command from the host computer, communicate with the firmware to identify deallocated logic block addresses (LBAs) within the storage device, terminate generation of the parity information for the identified deallocated LBAs in accordance with the firmware to avoid the garbage collection and respond to a read request from the host computer for the deallocated LBAs with a status code indicating a media error.

According to an aspect of one or more examples, there is provided a method of managing data in a storage device using a firmware stored in a memory. The method may include receiving the data from a host computer via a communication interface, and distributing the data across the storage device in accordance with a selected redundant array of independent disks (RAID) level. RAID functionality may be embedded within a single hard disk drive (HDD) and may be user-configurable. The method may include generating redundant data or parity information for the data based on the selected RAID level, storing the data and corresponding parity information or the redundant data within the storage device, and managing one or more reclaim groups and one or more reclaim units within the storage device to place the data and manage garbage collection. The parity information and the redundant data may be inaccessible by the host computer.

The storage device may include a non-volatile memory (NVM). The method may include detecting one or more errors in the data stored within the storage device. The method may include determining a reclaim group from the one or more reclaim groups or a reclaim unit from the one or more reclaim units with the one or more errors and using the parity information and a remaining portion of data blocks to recover the data from the determined reclaim group or the reclaim unit. The method, in response to an uncorrectable error in the selected RAID level, may include setting an array status of the selected RAID level to a degraded mode, and performing XOR operations on the remaining portion of the data blocks from one or more operational reclaim units within the determined reclaim group and the parity information to reconstruct the data.

The method may include determining a reclaim group from the one or more reclaim groups or a reclaim unit from the one or more reclaim units with the one or more errors and using the redundant data to reconstruct the data from the determined reclaim group or the reclaim unit. The redundant data may be inaccessible by the host computer. The method, in response to an uncorrectable error in the selected RAID level, may include setting an array status of the selected RAID level to a degraded mode and performing reconstruction of the data using mirrored data blocks of the redundant data from one or more operational reclaim units within the determined reclaim group.

The method may include dividing the data into the data blocks and distributing the data blocks across the one or more reclaim groups and the one or more reclaim units. The method may include performing the XOR operations on corresponding data blocks within each reclaim unit across the one or more reclaim groups to generate the parity information. The parity information may be inaccessible by the host computer. The method may include performing the XOR operations within each of the one or more reclaim groups to generate two sets of the parity information when the selected RAID level is RAID-6. The two sets of the parity information may be inaccessible by the host computer.

The method may include retrieving the mirrored data blocks from the redundant data within each of the one or more reclaim groups to reconstruct the data when the selected RAID level is RAID-1. The redundant region may be inaccessible by the host computer. The method may include receiving a database management command from the host computer, communicating with the firmware to identify deallocated logic block addresses (LBAs) within the storage device, terminating generation of the parity information for the identified deallocated LBAs in accordance with the firmware to avoid the garbage collection, and responding to a read request from the host computer for the deallocated LBAs with a status code indicating a media error.

### BRIEF DESCRIPTION OF DRAWINGS

FIG. 1 shows a block diagram illustrating an interactive environment for a system according to various examples.

FIG. 2 shows a block diagram illustrating a storage device operating in a mixed mode according to various examples.

FIG. 3 shows a block diagram illustrating a plurality of traditional redundant array of independent disks according to various examples.

FIG. 4 shows a block diagram illustrating a plurality of reclaim units in a storage device using XOR operations according to various examples.

FIG. 5 shows a block diagram illustrating a data placement scheme for a storage device according to various examples.

FIG. 6 shows a block diagram illustrating a method of managing data in a storage device using a firmware stored in a memory according to various examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Storage devices such as solid-state drives (SSDs) are increasingly used due to their high speed, reliability, and energy efficiency compared to traditional magnetic hard drives. The SSDs store data in storage media that is typically implemented with non-volatile memory (NVM). Unlike volatile memory, NVM retains stored data even when the power is turned off, making it suitable for long-term data storage. Large capacity SSDs are prone to various types of failures such as NAND cell degradation, DRAM errors, and uncorrectable errors as capacity scales up. To enhance the reliability and efficiency of data storage, the storage devices may implement a Redundant Array of Independent Disks (RAID). RAID distributes data across multiple storage devices to improve data redundancy and performance. Parity information is often generated to facilitate data recovery in case of storage media failure. However, RAID typically involves striping, which distributes data blocks across multiple storage devices and then generates parity information. This approach may not be suitable for all types of storage systems, particularly those that use logical data management and garbage collection processes. In SSDs, garbage collection is a process that consolidates free space by relocating valid data from blocks that have been partially written or deleted and then erasing the empty blocks to make them available for new data. This process may incur significant overhead and impact the performance and longevity of the storage device. Therefore, there is a need for an improved system and method for data management with adaptive RAID in a storage device implemented directly by a firmware.

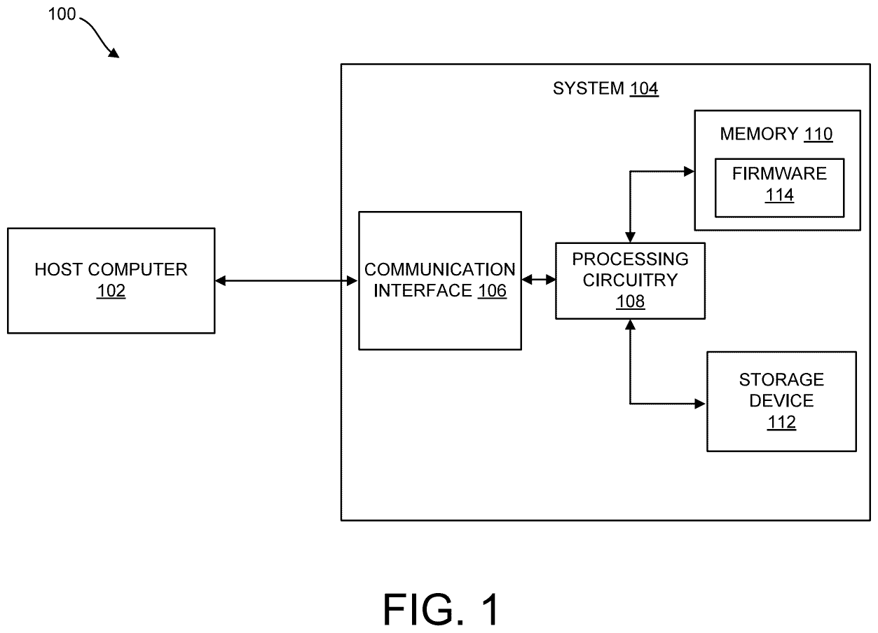

FIG. 1 shows a block diagram illustrating an interactive environment 100 for a system 104 according to various examples. The interactive environment 100 may include a host computer 102 and the system 104. The system 104 may include a communication interface 106, a processing circuitry, 108, a memory 110, and a storage device 112. The memory 110 may include a firmware 114.

The host computer 102 may serve as a primary interface for data transfer to and from the system 104. The host computer 102 may be a personal computer, a server, or any capable device to generate and process data that may be stored securely and efficiently. The host computer 102 may send and receive the data, commands, and control signals to the system 104 through the communication interface 106.

The storage device 112 of the system 104 may receive one or more input and output (I/O or IO) requests (which may also be referred to as commands) from the host computer 102 to enable the host computer 102 to access the storage device 112 (e.g., write the data into the storage media or read the data from the storage media). In one or more examples, the host computer 102 may divide the data into namespaces to isolate the data and efficiently access the data within the storage device 112. In addition to the namespaces, or as an alternative to the namespaces, the host computer 102 may divide and arrange the data into one or more reclaim groups based on logical block addresses (LBAs), to separate and manage the data based on one or more reclaim unit handles (RUHs) and one or more reclaim units.

The host computer 102 may set Redundant Array of Independent Disk (RAID) levels and adjust settings directly through the firmware 114 of the system 104. The host computer 102 may initiate Flexible Data Placement (FDP), utilizing the firmware 114 to strategically distribute the data across the storage device 112. By implementing the FDP, the system 104 may achieve enhanced efficiency and reduced wear on its memory components.

The data and the commands may be transferred between the host computer 102 and the system 104 through the communication interface 106. The communication interface 106 may be implemented with one or more interconnects, one or more networks, a network of networks (e.g., the internet), or a combination thereof, using any type of interface or protocol. In one or more examples, the communication interface 106 may include Peripheral Component Interconnect Express (PCIe), NVMe, NVMe-over-fabric (NVMe-oF), Ethernet, Transmission Control Protocol/Internet Protocol (TCP/IP), Direct Memory Access (DMA), Remote DMA (RDMA), RDMA over Converged Ethernet (ROCE), FibreChannel, InfiniBand, Serial ATA (SATA), Small Computer Systems Interface (SCSI), Serial Attached SCSI (SAS), iWARP, Compute Express Link (CXL), or a coherent protocol such as CXL.mem, CXL.cache, CXL.IO, Gen-Z, Open Coherent Accelerator Processor Interface (OpenCAPI), Cache Coherent Interconnect for Accelerators (CCIX), Advanced extensible Interface (AXI), any generation of wireless network including 2G, 3G, 4G, 5G, 6G, any generation of Wi-Fi, Bluetooth, near-field communication (NFC), or any combination thereof.

In one or more examples, the processing circuitry 108 of the system 104 may be responsible for executing the firmware 114 stored in the memory 110. The processing circuitry 108 may perform various operations including, but not limited to, managing data transfer operations, generating redundant data or parity information, and controlling the distribution of the data across the storage device 112. The processing circuitry 108 may also handle error detection and correction, ensuring data integrity within the storage device 112. The processing circuitry 108 may execute the firmware 114 that implement the RAID levels set by the host computer 102, perform the FDP to store the data and retrieve the data. Alternatively, the processing circuitry 108 may be a component within the host computer 102. In such implementation, the host computer 102 may offload certain processing tasks to its own processor while still utilizing the firmware 114 to manage the storage operations within the storage device 112, to provide more centralized control and potentially reduce latency in data management tasks.

The memory 110 may store the firmware 114, which is executable by the processing circuitry 108. The memory 110 may be, without limitation, a DDR (Data Double Rate) RAM (Random-Access Memory) media. In one or more examples, the memory 110 may be a standalone component within the system 104. Alternatively, the memory 110 may be a subcomponent of the storage device 112.

The firmware 114 stored in the memory 110, when executed by the processing circuitry 108, may enable the system 104 to perform various functions such as receiving data from the host computer 102, distributing the data across the storage device 112 in accordance with a selected RAID level, generating the redundant data or parity information for the data based on the selected RAID level, and storing the data and corresponding parity information or the redundant data within the storage device 112. The firmware 114 when executed may manage the one or more reclaim groups and the one or more reclaim units within the storage device 112 to place the data and manage garbage collection. The parity information and the redundant data may be inaccessible by the host computer.

The firmware 114 may include instructions within the memory 110 associated with a user-programmable RAID. The instructions embed RAID functionality directly within the firmware 114 of the memory 110 associated with the storage device 112, providing an additional layer of data recovery directly within the storage device 112, which may be an NVMe (Non-Volatile Memory Express) solid state device (SSD), enabling the recovery of data errors within the SSD. The RAID functionality may be utilized through an NVMe I/O (Input/Output) interface from an operating system, with operations commencing when the storage device 112 is connected and powered on. The firmware 114 may facilitate RAID reconstruction or repair of the data at a firmware level, thereby preventing data errors from causing system downtime.

The firmware 114 may support FDP, which is flexible and scalable enough to deploy the RAID functionality inside the firmware 114 of the memory 110 associated with the storage device 112. The firmware 114 may adapt the FDP to integrate the RAID functionality, to allow for an improved Write Amplification Factor (WAF) and enhanced performance and endurance. In one or more examples, the firmware 114 may support three modes of RAID setting: a RAID mode, a Host Bus Adapter (HBA) mode (non-RAID), and a mixed mode.

The storage device 112 may include a non-volatile memory (NVM), which retains stored data even when the power is turned off. The processing circuitry 108 may be responsible for executing the firmware 114 stored in the memory 110 to handle error detection and correction, to maintain integrity of the data within the storage device 112. In an event that the processing circuitry 108 detects one or more errors in the data stored within the storage device 112, the processing circuitry 108 may determine a reclaim group from the one or more reclaim groups or a reclaim unit from the one or more reclaim units with the one or more errors. The processing circuitry 108 may use the parity information and a remaining portion of data blocks to recover the data from the determined reclaim group or reclaim unit. The processing circuitry 108 may use mirrored data blocks of the redundant data from the determined reclaim group or reclaim unit to reconstruct the data. The parity information and the redundant data are inaccessible by the host computer.

Upon detection of an uncorrectable error in the selected RAID level, the processing circuitry 108 may set an array status of the selected RAID level to a degraded mode. In one or more examples, the processing circuitry 108 may perform XOR operations on the remaining portion of the data blocks from one or more operational reclaim units within the determined reclaim group and the parity information to reconstruct the data. The processing circuitry 108 may divide the data into the data blocks and distribute the data blocks across the one or more reclaim groups and the one or more reclaim units to manage data placement efficiently. For generating the parity information, the processing circuitry 108 may perform XOR operations on corresponding data blocks within each reclaim unit across the one or more reclaim groups. When the selected RAID level is RAID-6, the processing circuitry 108 may perform XOR operations within each of the one or more reclaim groups to generate two sets of the parity information. The two sets of the parity information may be inaccessible by the host computer. The processing circuitry 108 may retrieve the mirrored data blocks from the redundant data within each of the one or more reclaim groups to reconstruct the data when the selected RAID level is RAID-1.

The processing circuitry 108 may receive a database management command from the host computer 102. The processing circuitry 108 may then communicate with the firmware 114 to identify deallocated LBAs within the storage device 112. The processing circuitry 108 may terminate generation of the parity information for the identified deallocated LBAs in accordance with the firmware 114 to avoid unnecessary garbage collection. The processing circuitry 108 may respond to a read request from the host computer 102 for the deallocated LBAs with a status code indicating a media error.

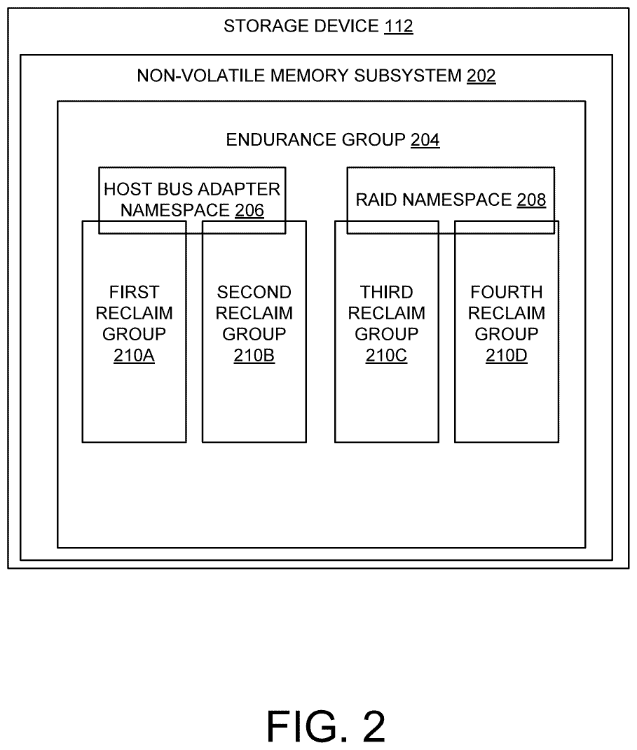

FIG. 2 shows a block diagram illustrating a storage device 112 operating in a mixed mode according to various examples. The storage device 112 may include a non-volatile memory subsystem 202. The non-volatile memory subsystem 202 may include an endurance group 204. The endurance group 204 may include a host bus adapter (HBA) namespace 206 and a RAID namespace 208. The endurance group 204 within the non-volatile memory subsystem 202 may manage the data stored in different namespaces, namely the HBA namespace 206 and the RAID namespace 208. The HBA namespace 206 may be designed for non-RAID settings, allowing direct access to storage media without overhead of the RAID functionality. The HBA namespace may be used to swiftly access the data without the redundancy.

The RAID namespace 208, on the other hand, may handle the data with the RAID functionalities. The RAID functionality may be implemented directly within the firmware 114, as described earlier, to allow efficient data recovery and management within the storage device 112. Within the endurance group 204, the storage device 112 may include multiple reclaim groups. In one or more examples, the HBA namespace 206 may include a first reclaim group 210A and a second reclaim group 210B. Similarly, the RAID namespace 208 may include a third reclaim group 210C and a fourth reclaim group 210D. The reclaim groups may organize and manage data blocks within their respective namespaces.

Each reclaim group (210A, 210B, 210C, 210D) may manage a portion of the non-volatile memory within the storage device 112. The reclaim groups may be utilized to facilitate efficient data placement, garbage collection, and wear leveling. In one or more examples, when the data is written or updated, the reclaim groups may distribute the data blocks across different memory locations to enhance performance and extend the lifespan of the storage media. The first reclaim group 210A and the second reclaim group 210B within the HBA namespace 206 may handle the data blocks without the RAID functionalities, focusing on direct, high-speed access. The reclaim groups 210A and 210B may support deallocation of the LBAs without garbage collection.

The third reclaim group 210C and the fourth reclaim group 210D within the RAID namespace 208, may utilize the RAID functionalities. The reclaim groups 210C and 210D manage the data blocks with additional redundancy information (such as the parity information), to enable the data recovery in an event of a memory failure. The processing circuitry 108, executing the firmware 114, may perform XOR operations on the data blocks within the reclaim groups 210C and 210D to generate and store the parity information. By combining both HBA and RAID namespaces 206 and 208 within the endurance group 204, the storage device 112 may operate in a mixed mode. The mixed mode may allow the storage device 112 to cater to a range of data storage provisions, from high-speed, low-latency access to robust data integrity and recovery mechanisms.

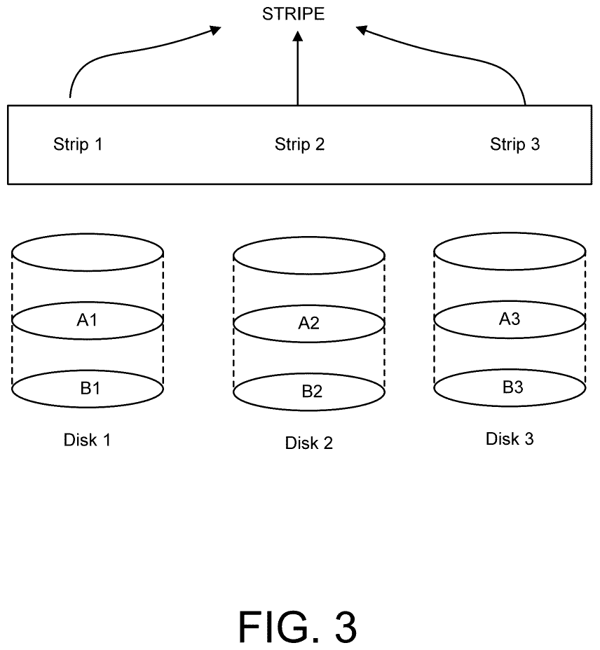

FIG. 3 shows a block diagram illustrating a plurality of redundant array of independent disks according to one or more examples. In RAID, data is distributed across multiple disks. As depicted in FIG. 3, the RAID may include multiple disks, such as Disk 1, Disk 2, and Disk 3. The data may be divided into units referred to as “strips” (e.g., Strip 1, Strip 2, and Strip 3), which may be then combined to form a “stripe” distributed across the multiple disks. Each disk may hold portions of the data stripes.

In one or more examples, one stripe may include Strip A1 from Disk 1, Strip A2 from Disk 2, and Strip A3 from Disk 3. Similarly, another stripe may include Strip B1 from Disk 1, Strip B2 from Disk 2, and Strip B3 from Disk 3. The striping may enable the RAID to read and write data concurrently from multiple disks. Parity information may be generated and stored across the disks to ensure data integrity and facilitate data recovery in the event of a disk failure. In the RAID, multiple physical drives may be used to achieve data redundancy. Using the multiple physical drives may be cost inefficient, increase space and power consumption, and may be complex.

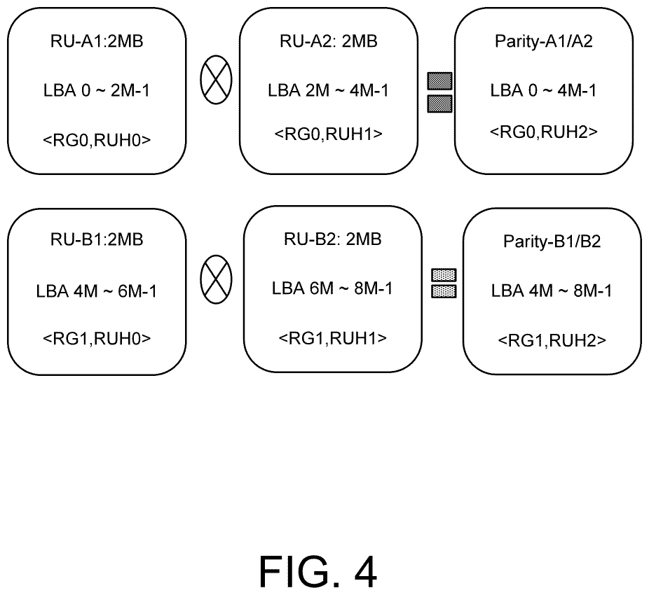

FIG. 4 shows a block diagram illustrating a plurality of reclaim units in the storage device 112 using XOR operations according to one or more examples. The storage device 112 may utilize XOR operations to generate the parity information for the data stored across the plurality of reclaim units, facilitating data recovery and ensuring data integrity within the storage device 112. The XOR operations may generate the parity information for two sets of reclaim units (RUs) within different reclaim groups (RGs). In one or more examples, a size of each reclaim unit may be about 2 MB. Alternatively, the size of each reclaim unit may vary. Each reclaim unit may be associated with a range of logical block addresses (LBAs).

The reclaim units RU-A1 and RU-A2 may be associated with the reclaim group RG0. The RU-A1 may store data blocks within the LBA range of about 0 to 2M−1, and RU-A2 may store data blocks within the LBA range of about 2M to 4M−1. The data blocks from the reclaim units RU-A1 and RU-A2 may be processed through the XOR operation to generate the parity information for the LBA range of about 0 to 4M−1, which is stored in a reclaim unit designated as Parity-A1/A2. The Parity-A1/A2 reclaim unit may be a part of the reclaim group RG0 and identified by RUH2.

Similarly, the reclaim units RU-B1 and RU-B2 may be associated with the reclaim group RG1. RU-B1 may store data blocks within the LBA range of about 4M to 6M−1, and RU-B2 may store data blocks within the LBA range of about 6M to 8M−1. The data blocks from the reclaim units RU-B1 and RU-B2 may be processed through the XOR operation to generate the parity information for the LBA range of about 4M to 8M−1, which is stored in a reclaim unit designated as Parity-B1/B2. The Parity-B1/B2 reclaim unit may be a part of the reclaim group RG1 and identified by RUH2. The XOR operations to generate the parity information may allow efficient data recovery in an event of data errors or reclaim unit failures. If a data error is detected in any of the reclaim units (e.g., RU-A1 or RU-A2), the system 104 may utilize the corresponding parity information (e.g., Parity-A1/A2) to reconstruct the data and ensure data integrity.

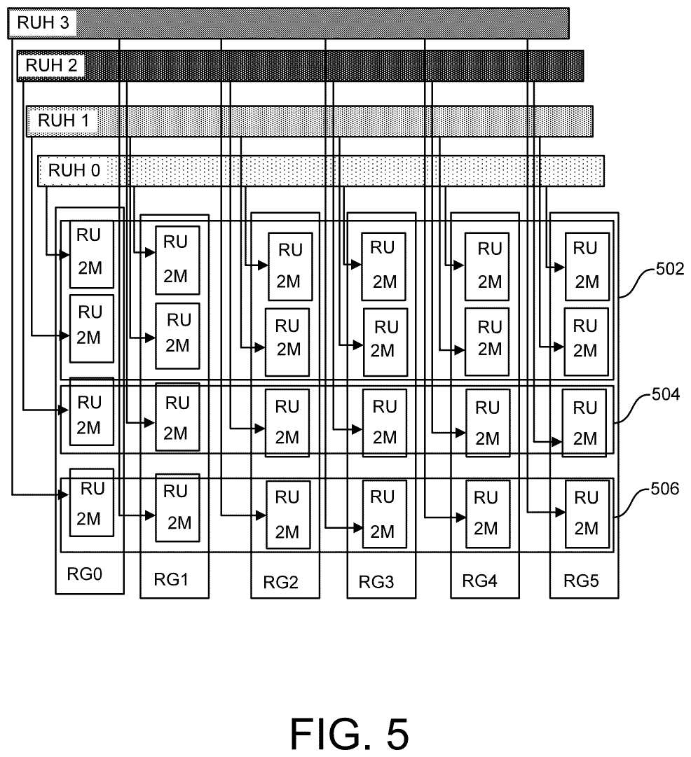

FIG. 5 shows a block diagram illustrating a data placement scheme for a storage device 112 according to one or more examples. The storage device 112 may utilize a structured data placement scheme to manage data storage and retrieval, employing multiple reclaim groups (RGs) and reclaim unit handles (RUHs).

In one or more examples, the data placement scheme for the storage device 112 may be organized into the reclaim groups, RG0 through RG5, each including multiple reclaim units (RUS). A size of each RU is about 2 MB according to various examples, though other sizes may be used. The RUs may be distributed across different reclaim unit handles, RUH0 through RUH3. The hierarchical organization may facilitate efficient data management, wear leveling, and error recovery within the storage device 112.

The reclaim groups (RGs) may serve as logical partitions within the storage device 112, each including several RUs. Such arrangement may support managing data placement and retrieval operations, in addition to maintaining data integrity through redundancy and the parity information. The reclaim unit handles (RUHs) may represent different layers of abstraction within the storage device 112, to allow flexible data placement and access. Each RUH (RUH0, RUH1, RUH2, and RUH3) may include several RUs from different RGs. In one or more examples, RUH0 may include RUs from RG0 to RG5, each RU of the size of about 2 MB.

The data placement scheme may use the XOR operations to generate the parity information for the data stored in the RUs. The parity information may be used for data recovery in case of data errors or RU failures. In one or more examples, data blocks stored in RUs under RUH0 and RUH1 may be XORed to generate the parity information, which may be stored in a designated parity RU within the same RG but different RUH (e.g., RUH2). The parity information may be inaccessible by the host computer.

The box labeled 502 may represent a 24 MB area where the selected RAID level is RAID-5 (R5) and indicate the region where RAID-on-NAND is implemented. The box labeled 502 may include multiple RUs organized under the RUH0 and the RUH1, enabling the RAID functionality directly within the storage device 112. The box labeled 504 may represent the parity region for the RAID level R5, where the parity information generated from the XOR operations is stored. The box labeled 504 may enable data redundancy and facilitate data recovery in case of any RU failures within the RAID-5. The parity region at the box labeled 504 may be inaccessible by the host computer 102. The box labeled 506 may represent a 12 MB area designated for a Host Bus Adapter (HBA) namespace (NS), which may operate in a non-RAID mode. The box labeled 506 may include RUs dedicated to handling non-RAID data storage and retrieval operations. The use of multiple RUHs and RGs may enable the data to spread out across the storage device 112, reducing possibility of data loss due to localized failures. The data placement scheme may improve efficiency of garbage collection processes by allowing the system 104 to manage deallocated blocks and reclaim space more effectively.

In one or more alternative examples, the box labeled 502 may represent a 24 MB area designated for a Host Bus Adapter (HBA) namespace (NS), which may operate in a non-RAID mode. The box labeled 502 may include RUs dedicated to handling non-RAID data storage and retrieval operations. The box labeled 502 may include multiple RUs organized under the RUH0 and the RUH1. The box labeled 504 may represent a 12 MB area designated as the data region for the RAID level R1. The box labeled 506 may represent a 12 MB redundant data area for the RAID level R1. The box labeled 504 may enable data redundancy by having the mirrored data blocks on the region located at the box labeled 506. The redundant region at the box labeled 506 may be inaccessible by the host computer 102. Upon detection of an uncorrectable error in the RAID level R1 due to data errors or RU failures, the mirrored data blocks in the area of the box labeled 506 may be retrieved to reconstruct the data.

In one or more examples, the firmware 114 within the memory 110 associated with the storage device 112 may manage the data placement scheme. The firmware 114 may include instructions to implement the FDP, which may dynamically allocate and reallocate data blocks across different RUs and RGs based on usage patterns and wear leveling conditions. The FDP may reduce the Write Amplification Factor by improving the placement of data blocks and reducing frequent write and erase cycles. By placing the data across the RUs and RGs, the storage device 112 may execute stable and predictable performance, even under varying workload demands.

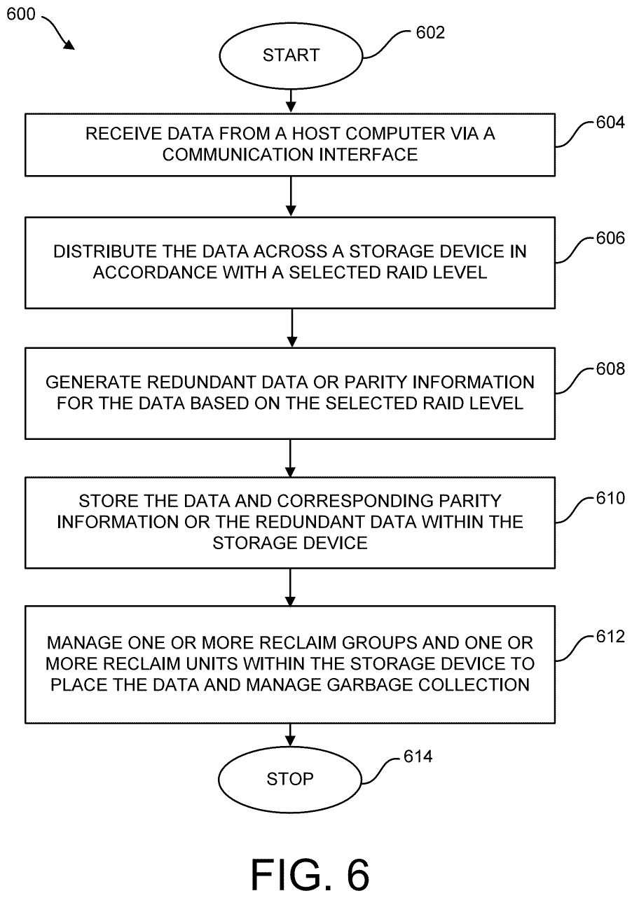

FIG. 6 shows a flowchart 600 illustrating a method of managing data in a storage device using a firmware stored in a memory according to one or more examples. It may be noted that in order to explain the method operations of the flowchart 600, references will be made to the elements explained in FIG. 1.

The flowchart 600 starts at operation 602. At operation 604, the method may include receiving data from the host computer 102 via a communication interface 106. At operation 606, the method may include distributing the data across the storage device 112 in accordance with a selected RAID level, wherein RAID functionality is embedded within a single hard disk drive (HDD) and is user-configurable. At operation 608, the method may include generating redundant data or parity information for the data based on the selected RAID level. At operation 610, the method may include storing the data and corresponding parity information or the redundant data within the storage device 112. At operation 612, the method may include managing one or more reclaim groups and one or more reclaim units within the storage device 112 to place the data and manage garbage collection.

The flowchart 600 terminates at operation 614. It may be noted that the flowchart 600 is explained to have above stated process operations; however, those skilled in the art would appreciate that the flowchart 600 may have more/less number of process operations which may enable all the above stated examples of the present disclosure.

Various examples have been disclosed herein, in connection with the above description and the drawings. It will be understood that it would be unduly repetitious to literally describe and illustrate each combination and subcombination of these examples. Accordingly, all examples can be combined in any way or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it is to be noted that all of the accompanying drawings are not to scale. A variety of modifications and variations are possible in light of the above teachings.

What is claimed is:

1. A system comprising:
a processing circuitry;
a memory coupled to the processing circuitry;
a storage device coupled to the processing circuitry;
a communication interface for data transfer with a host computer;
a firmware stored in the memory which when executed by the processing circuitry, causes the processing circuitry to:
receive data from the host computer via the communication interface;
distribute the data across the storage device in accordance with a selected redundant array of independent disk (RAID) level, wherein RAID functionality is embedded within a single hard disk drive (HDD) and configured by a user;
generate redundant data or parity information for the data based on the selected RAID level;
store the data and corresponding parity information or the redundant data within the storage device; and
manage one or more reclaim groups and one or more reclaim units within the storage device to place the data and manage garbage collection.

2. The system of claim 1, wherein the storage device comprises a non-volatile memory (NVM).

3. The system of claim 1, wherein the processing circuitry is to detect one or more errors in the data stored within the storage device.

4. The system of claim 3, wherein the processing circuitry is to:
determine a reclaim group from the one or more reclaim groups or a reclaim unit from the one or more reclaim units with the one or more errors; and
use the parity information and a remaining portion of data blocks to recover the data from the determined reclaim group or reclaim unit, wherein the parity information is inaccessible by the host computer.

5. The system of claim 4, wherein the processing circuitry, in response to an uncorrectable error in the selected RAID level, is to:
set an array status of the selected RAID level to a degraded mode; and
perform XOR operations on the remaining portion of the data blocks from one or more operational reclaim units within the determined reclaim group and the parity information to reconstruct the data.

6. The system of claim 3, wherein the processing circuitry is to:
determine a reclaim group from the one or more reclaim groups or a reclaim unit from the one or more reclaim units with the one or more errors; and
use the redundant data to recover the data from the determined reclaim group or reclaim unit, wherein the redundant data is inaccessible by the host computer.

7. The system of claim 6, wherein the processing circuitry, in response to an uncorrectable error in the selected RAID level, is to:
set an array status of the selected RAID level to a degraded mode; and
perform reconstruction of the data using mirrored data blocks of the redundant data from one or more operational reclaim units within the determined reclaim group.

8. The system of claim 1, wherein the processing circuitry is to perform dividing of the data into data blocks and distributing the data blocks across the one or more reclaim groups and the one or more reclaim units.

9. The system of claim 1, wherein the processing circuitry is to perform XOR operations on corresponding data blocks within each reclaim unit across the one or more reclaim groups to generate the parity information which is inaccessible by the host computer.

10. The system of claim 1, wherein the processing circuitry is to perform XOR operations within each of the one or more reclaim groups to generate two sets of the parity information when the selected RAID level is RAID-6, wherein the two sets of the parity information are inaccessible by the host computer.

11. The system of claim 1, wherein the processing circuitry is to perform retrieving of mirrored data blocks from the redundant data within each of the one or more reclaim groups to reconstruct the data when the selected RAID level is RAID-1, wherein the redundant data is inaccessible by the host computer.

12. The system of claim 1, wherein the process is to:
receive a database management command from the host computer;
communicate with the firmware to identify deallocated logic block addresses (LBAs) within the storage device;
terminate generation of the parity information for the identified deallocated LBAs in accordance with the firmware to avoid the garbage collection; and
respond to a read request from the host computer for the deallocated LBAs with a status code indicating a media error.

13. A method of managing data in a storage device using a firmware stored in a memory, the method comprising:
receiving the data from a host computer via a communication interface;
distributing the data across the storage device in accordance with a selected redundant array of independent disks (RAID) level, wherein RAID functionality is embedded within a single hard disk drive (HDD) and is user-configurable;
generating redundant data or parity information for the data based on the selected RAID level;
storing the data and corresponding parity information or the redundant data within the storage device; and
managing one or more reclaim groups and one or more reclaim units within the storage device to place the data and manage garbage collection.

14. The method of claim 13, wherein the storage device comprises a non-volatile memory (NVM).

15. The method of claim 13, further comprising detecting one or more errors in the data stored within the storage device.

16. The method of claim 15, further comprising:
determining a reclaim group from the one or more reclaim groups or a reclaim unit from the one or more reclaim units with the one or more errors; and
using the parity information and a remaining portion of data blocks to recover the data from the determined reclaim group or the reclaim unit, wherein the parity information is inaccessible by the host computer.

17. The method of claim 16, further comprising:
in response to an uncorrectable error in the selected RAID level:
setting an array status of the selected RAID level to a degraded mode; and
performing XOR operations on the remaining portion of the data blocks from one or more operational reclaim units within the determined reclaim group and the parity information to reconstruct the data.

18. The method of claim 15, further comprising:
determining a reclaim group from the one or more reclaim groups or a reclaim unit from the one or more reclaim units with the one or more errors; and
using the redundant data to recover the data from the determined reclaim group or the reclaim unit, wherein the redundant data region is inaccessible by the host computer.

19. The method of claim 18, further comprising:
in response to an uncorrectable error in the selected RAID level:
setting an array status of the selected RAID level to a degraded mode; and
performing to retrieve the mirrored copy of the data blocks from one or more operational reclaim units within the determined reclaim group to recover the data.

20. The method of claim 13, further comprising dividing the data into data blocks and
distributing the data blocks across the one or more reclaim groups and the one or more reclaim units.

21. The method of claim 13, further comprising performing XOR operations on
corresponding data blocks within each reclaim unit across the one or more reclaim groups to generate the parity information which is inaccessible by the host computer.

22. The method of claim 13, further comprising performing XOR operations within
each of the one or more reclaim groups to generate two sets of the parity information when the selected RAID level is RAID-6. The two sets of the parity information are inaccessible by the host computer.

23. The method of claim 13, further comprising retrieving mirrored data blocks from the redundant data within each of the one or more reclaim groups to reconstruct the data when the selected RAID level is RAID-1, wherein the redundant data is inaccessible by the host computer.

24. The method of claim 13, further comprising:
receiving a database management command from the host computer;
communicating with the firmware to identify deallocated logic block addresses (LBAs) within the storage device;
terminating generation of the parity information for the identified deallocated LBAs in accordance with the firmware to avoid the garbage collection; and
responding to a read request from the host computer for the deallocated LBAs with a status code indicating a media error.
